(19) United States
(12) Patent Application Publication
(10) Pub. No.: US 2007/0123314 A1
(43) Pub. Date: May 31, 2007

(54) Low power mode for a multiple function handheld device

(76) Inventor: Thomas Glen Ragan, Austin, TX (US)

Correspondence Address: GARLICK HARRISON & MARKISON, P.O. BOX 160727, AUSTIN, TX, 78716-0727, US

(21) Appl. No.: 11/290,052

(22) Filed: Nov. 30, 2005

(51) Int. Cl. H04B 1/38

(52) U.S. Cl. 455/572

(57) ABSTRACT

A method begins by monitoring a battery voltage. The method continues by comparing the battery voltage with a threshold voltage. The method continues, when the battery voltage compares unfavorably to the threshold voltage, by establishing the first power state. The method continues by disabling at least a portion of a digital audio processing functionality in response to the first power state. The method continues by enabling wireless communication functionality in response to the first power state.

### CROSS REFERENCE TO RELATED PATENTS

This patent application relates to co-pending patent application entitled MULTIPLE FUNCTION HANDHELD DEVICE, having an attorney docket number of SIG000229.

### STATEMENT REGARDING FEDERALLY SPONSORED RESEARCH OR DEVELOPMENT

NOT APPLICABLE

### INCORPORATION-BY-REFERENCE OF MATERIAL SUBMITTED ON A COMPACT DISC

NOT APPLICABLE

### BACKGROUND OF THE INVENTION

1. Technical Field of the Invention

This invention relates generally to handheld devices and more particularly to modes of a handheld device.

2. Description of Related Art

Integration of conventionally separate handheld devices into a single handheld device is current trend in the art. For instance, cellular telephones have been integrated with personal digital assistants (PDA), digital cameras, and walkie-talkie functionality. More recently, cellular telephones have been integrated with digital audio players (e.g., MP3 and/or WMA players). Such integration provides the user of a handheld device the convenience of carrying one device with the functionality of two or more devices.

While an integrated handheld device provides multiple functionalities, there are some instances and/or locations, where the user cannot or should not use one or more of the functionalities. For instance, current Federal Aviation Administration (FAA) prohibits the use of cellular telephones on airplanes in transit, but allows the use of other handheld devices (e.g., PDA, digital audio player). In such instances, to comply with FAA regulations, a cellular telephone with additional integrated functions (e.g., PDA, digital audio player) the entire handheld device must be powered down. Thus, the user is not able to use the approved functionality of the handheld device.

An ongoing design challenge with handheld devices is to reduce power consumption thereby increasing battery life (i.e., the duration for which a handheld device can operate properly without recharging or replacing its battery source). When the handheld device includes integration of multiple functionalities, reduction of power consumption is an even greater challenge. In some handheld devices, certain functions may be disabled based on available power.

Therefore, a need exists for a handheld device that provides greater flexibility of use and/or controlled power consumption.

### BRIEF DESCRIPTION OF THE SEVERAL VIEWS OF THE DRAWING(S)

FIG. 1 is an exploded view of a cellular telephone with digital audio and/or video in accordance with the present invention;

FIG. 2 is a schematic block diagram of a cellular telephone with digital audio in accordance with the present invention;

FIG. 3 is a schematic block diagram of a cellular telephone with a plurality of functional circuits in accordance with the present invention;

FIG. 4 is a schematic block diagram of a multiple function handheld device in accordance with the present invention;

FIG. 5 is a schematic block diagram of another embodiment of a multiple function handheld device in accordance with the present invention;

FIG. 6 is a schematic block diagram of yet another embodiment of a multiple function handheld device in accordance with the present invention;

FIG. 7 is a schematic block diagram of a still further embodiment of a multiple function handheld device in accordance with the present invention;

FIG. 8 is a schematic block diagram of yet another embodiment of a multiple function handheld device in accordance with the present invention;

FIG. 9 is a logic diagram of a method for enabling portions of a multiple function handheld device in accordance with the present invention;

FIG. 10 is a logic diagram of a method for enabling portions of a multiple function handheld device based on power states in accordance with the present invention; and

FIG. 11 is a logic diagram of a method for determining when a multiple function handheld device is in a 1st power state in accordance with the present invention.

### DETAILED DESCRIPTION OF THE DRAWINGS

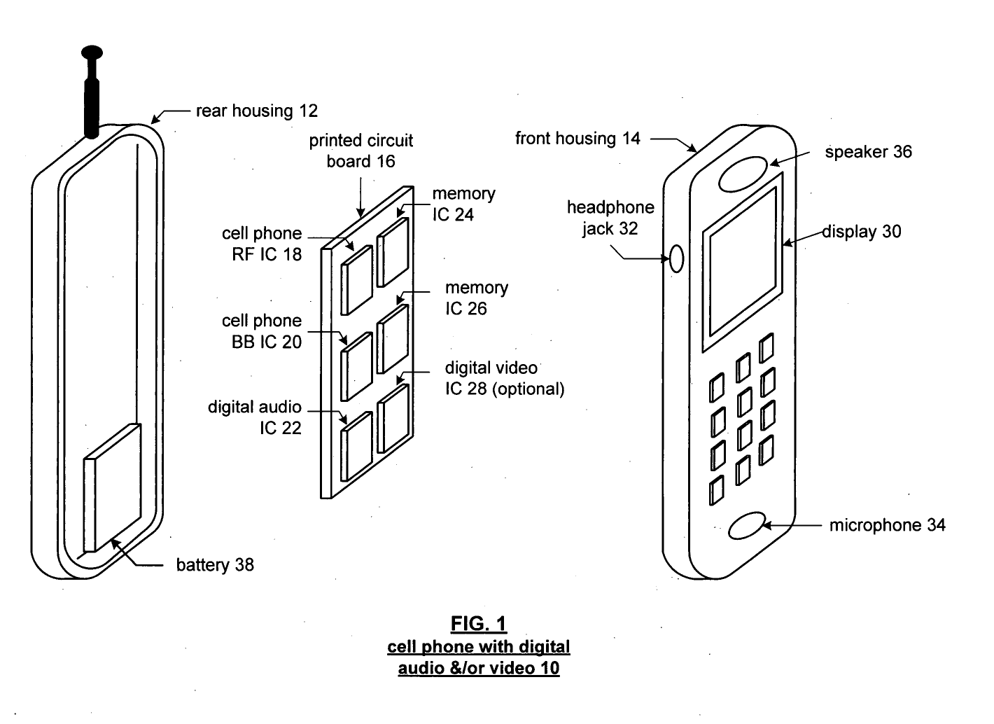

FIG. 1 is an exploded diagram of a cellular telephone 10 with digital audio and/or video functional circuitry. As shown, the cellular telephone 10 includes a rear housing 12, a front housing 14, and a printed circuit board 16. The rear housing 12 may support a battery 38. The front housing 14 may include a display 30, a headphone jack 32, a microphone 34, a speaker 36 and an input control pad. The printed circuit board 16 may include one or more printed circuit boards that support a plurality of integrated circuits. Such integrated circuits may include a cellular phone radio frequency (RF) integrated circuit (IC) 18, a cellular telephone baseband (BB) integrated circuit 20, a digital audio integrated circuit 22, memory integrated circuits 24, 26 and may further include a digital video integrated circuit 28.

The cellular telephone 10, in a wireless communication mode of operation, may be used to support wireless communications such as cellular telephone communications, walkie-talkie communications, and/or dispatch communications. The cellular telephone 10 may alternatively operate in a digital audio mode to playback and/or record digital audio files. Such digital audio files may be in an MP3 format, WMA format and/or any other proprietary and/or standardized digital audio format. If the cellular telephone 10 includes video processing functionality (e.g., as may be performed by IC 28, or multiple ICs not shown), it may operate in a video mode to capture and/or play back still and/or motion video images. Such video images may be formatted in accordance with one or more video standards such as MPEG (motion picture expert group), JPEG (Joint Photographic Experts Group), etc.

The cellular telephone 10 may further include integrated circuits, and/or functionality within existing integrated circuits, to support a personal digital assistant (PDA) function. Such a personal digital assistant function allows task management, calendar management, contact list management, note management, et cetera. Accordingly, the cellular telephone 10 is a multiple function handheld device that enables a user to selectively utilize a variety of functional circuits (e.g., digital audio playback/record, digital video playback/record, PDA functions, and/or wireless communication functions).

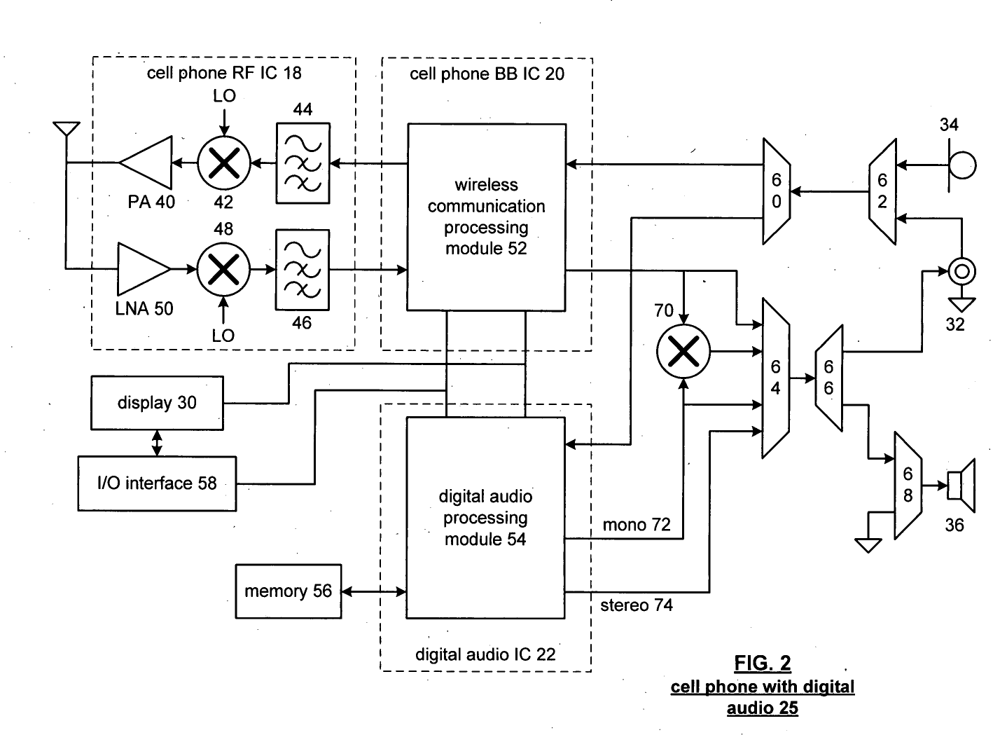

FIG. 2 is a schematic block diagram of the cellular telephone 25 that includes digital audio functionality. In this embodiment, the cellular telephone 25 includes the cellular telephone RFIC 18, the cellular telephone baseband IC 20, the digital audio IC 22, the display 30, an I/O interface 58, memory 56 (which may be included in one or more of integrated circuits 24 and 26), a plurality of multiplexers 60-68, a mixing module 70, the microphone 34, the headphone jack 32, and the speaker 36. The cellular telephone RF IC 18 may include a direct IF conversion topology or a super heterodyne conversion technology. In general, the cellular telephone RFIC 18 includes a low noise amplifier 50, a mixing module 48, and a low pass filter 46 for-receiving RF signals and includes a low pass filter 44, mixing module 42 and a power amplifier 40 for transmitting RF signals. The cellular telephone baseband IC 20 includes a wireless communication processing module 52. The digital audio IC 22 includes a digital audio processing module 54. In one embodiment, the digital audio processing IC may be an STMP 35xx and/or an STMP 36xx as produced and manufactured by SigmaTel, Inc.

The wireless communication processing module 52 and the digital audio processing module 54 may each be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. Each processing module 53 and/or 54 may have associated therewith a memory element that may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module 52 and/or 54 implements one or more of its functions via a state machine, analog circuitry, digital circuitry, and/or logic circuitry, the memory element storing the corresponding operational instructions may be. embedded within, or external to, the circuitry comprising the state machine, analog circuitry, digital circuitry, and/or logic circuitry. Further note that, the memory element stores, and the processing module. 52 and/54 executes, operational instructions corresponding to at least some of the steps and/or functions illustrated in FIGS. 1-11.

The cellular telephone 25 may be placed in a variety of different operating modes based on a mode selection. The mode selection may be received from the user via the I/O interface 58, which may be a USB (universal serial bus) interface, an infrared interface, a keyboard, I²C interface, et cetera. The particular mode selection may be processed by the wireless communication processing module 52 and/or the digital audio processing module 54. Alternatively, the cellular telephone 25 may receive an RF signal via the cellular telephone RF IC 18 indicating a particular mode of operation. For example, upon entering a hospital, an RF control signal may be broadcast in the lobby indicating that cellular telephone use is not allowed within the hospital. Upon receiving this RF signal, the cellular telephone automatically disables the wireless communication functionality of the cellular telephone while leaving the digital audio processing functionality in the state of operation specified by the user (e.g., enabled or disabled). Accordingly, the user may enable or disable the digital audio functionality of the cellular telephone with the wireless communication functionality disabled. Such a feature is also beneficial for air travel, where many governmental agencies (e.g., Federal Aviation Agency—FAA) prohibit the use of cellular telephones on an airplane, but allow the use of CD players and MP3 players

In addition to disabling the wireless communication function and enabling the digital audio processing functionality, the user may place the cellular telephone in a second mode where the digital audio functionality is disabled and the wireless communication functionality is enabled. Further, the user may place the cellular telephone in a third mode where both the wireless communication functionality and the digital audio processing functionality are enabled. Still further, the user may place the cellular telephone in a fourth mode where both the wireless communication processing functionality and the digital audio processing functionality are disabled. Such selective. enabling and disabling of circuit functionalities of the cellular telephone allows the user to maintain certain functionalities while disabling others, which, in some instances, allows the user to comply with particular regulations of the environment in which the user is located (e.g., on an airplane) and/or to reduce power consumption by disabling functional circuitry that the user does not desire to use.

When the digital audio processing functionality is enabled, the digital audio processing module 54 may function in a playback mode where it retrieves stored digital audio files from memory 56 and produces therefrom a monotone audio output 72 and/or a stereo audio output 74. The audio outputs 72 and 74 may be in an analog format or a digital format. If the wireless communication processing functionality is disabled, the cellular telephone will provide the stereo audio output 74 to the headphone jack 32 via multiplexer 64 and 66 when a headphone is plugged into headphone jack 32. If a headphone is not being used, multiplexers 64, 66 and 68 provide the monotone audio output 72 (which may be produced by summing the left and right channels of the stereo audio output) to speaker 36. Note that when a headphone is plugged into headphone jack 32 multiplexer 68 provides a mute signal to speaker 36.

In a record mode, the digital audio processing module 54 receives an audio input via microphone 34 and multiplexers 62 and 60. The digital audio processing module 54 converts the audio signals into a digital audio file that may be stored in memory 56. In this mode, the digital audio processing module 54 is functioning as a digital voice recorder.

When the wireless communication processing functionality is enabled and the digital audio processing functionality is disabled, the wireless communication processing module 52 processes incoming communications via the LNA 50, mixing module 48 and low pass filter 46 of the cellular telephone RF IC 18 to produce analog signals. The analog signals are provided either to a headphone via the headphone jack 32 or to the speaker 36 via multiplexers 64, 66 and 68. For outgoing communications, analog signals are received via microphone 34 and multiplexers 62 and 60. The wireless communication processing module 52 converts the analog signals into baseband symbols, which are then converted into RF signals via the low pass filter 44, mixing module 42 and power amplifier 40.

In a mode when both the wireless communication processing functionality and digital audio processing functionality are enabled, the received wireless communication signals may be mixed via mixer 70 with the monotone audio output 72 of the digital audio processing module 54. This allows for background music, to be played while a wireless communication is active. In one embodiment, the monotone audio output 72 may be scaled to a volume level such that it does not substantially interfere with the ongoing wireless communication.

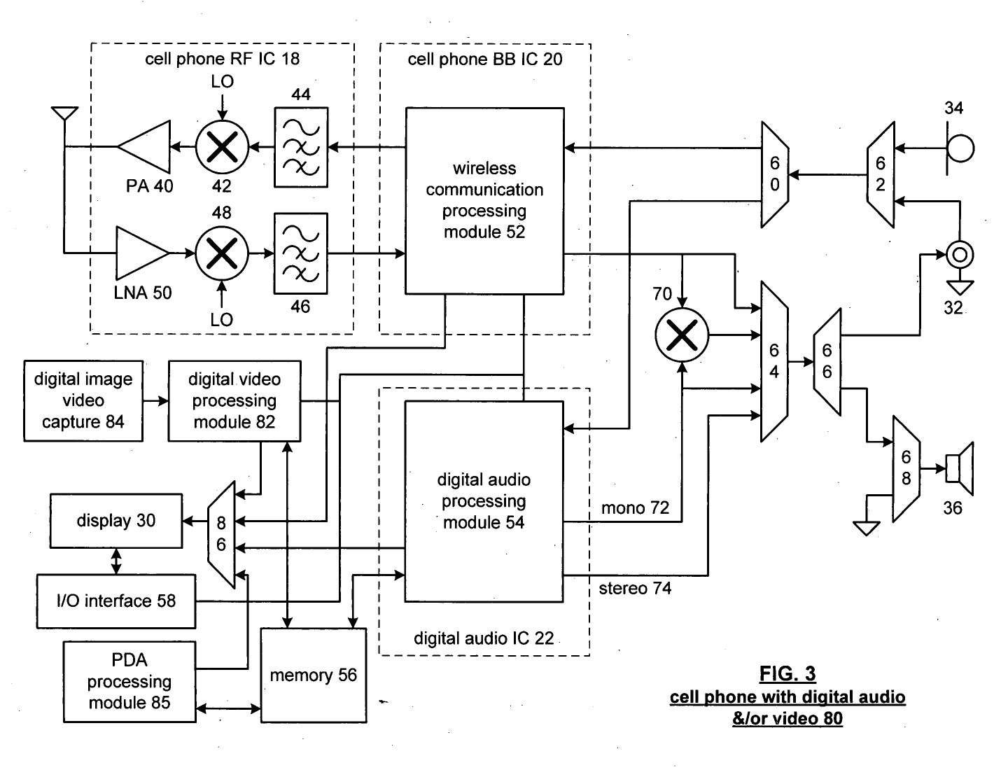

FIG. 3 is a schematic block diagram of a cellular telephone 80 that includes a plurality of functional circuits. The functional circuits include, but are not limited to, digital audio processing, digital video processing, digital video capture, and/or personal digital assistant (PDA) functionality. In this embodiment, the cellular telephone 80 includes the cellular telephone RF IC 18, the cellular telephone baseband IC 20, the digital audio IC 22, memory 56, a digital image video capture module 84, a digital video processing module 82, the display 30, the 10 interface 58, a PDA processing module 85, multiplexers 60-68 and 86, the headphone jack 32, the microphone 34, and the speaker 36. As with the embodiment of FIG. 2, the wireless communication processing module 52 may support cellular telephone communications (e.g., one to one), walkie talkie communications (e.g., one to many), and/or dispatch communications (e.g., many to one). In addition, the digital audio processing module 54 may support digital audio playback, digital audio record, file transfer, digital audio encode and digital audio decode. The audio input and output via microphone 34 and headphone jack 32 or speaker 36 function as previously described with reference to FIG. 2.

The digital image video capture module 84 may be a digital recorder that captures still images and/or motion video images. The digital representation of the image and/or motion video is provided to the digital video processing module 82, which converts the received image and/or motion video into a corresponding digital video file, which may be formatted in accordance with MPEG, JPEG, a proprietary digital video image storage scheme and/or other standardized video digital image storage schemes. Accordingly, the digital video processing module 82 provides functionality for one or more of digital motion video playback, digital still image video playback, digital motion video record, digital still image record, digital video encoding, and/or digital video decoding.

The PDA processing module 85 enables the cellular telephone to provide the user with PDA functionality, which includes, but is not limited to, calendar management, task management, note management, and/or contact information management. The digital video processing module 82 and/or the PDA processing module 85 may be separate integrated circuits and/or combined with one or more of the wireless communication processing module 52 and the digital audio processing module 54.

Multiplexer 86 selects a video output to be provided to display 30. For example, in one mode, the multiplexer 86 may pass the video output from the digital video processing module 82 to display 30. The video output may be in an analog or digital format depending on the type of display and may include still images and/or motion video. Alternatively, the multiplexer 86 may provide an output from the wireless communication processing module 52 indicating information relevant to a wireless communication. As yet another alternative, the multiplexer 86 may output information regarding a digital audio file record and/or playback. As yet another option, multiplexer 86 may output a PDA signal that corresponds to a particular PDA function. In either mode, the IO interface 58 provides a corresponding input to one or more of the processing modules 52, 54, 82, and 85. In this embodiment, the cellular telephone 80 includes a plurality of functional circuits (e.g., wireless communication functionality, digital audio processing functionality, digital video processing functionality, digital image capturing, and PDA functionality). Accordingly, the user may actively select one or more of the circuit functionalities to be active at any given time, or the selection may be an automatic function of the cellular telephone, to comply with particular regulations of the environment in which the user is located (e.g., on an airplane), and/or to conserve power.

In another embodiment, the cellular telephone via one or more of the processing modules and/or a control module (not shown in FIG. 3, but is shown in subsequent figures) monitors the battery voltage of the cellular telephone. Based on the power level of the battery, the processing module and/or control module enables and/or disables circuit functionality in accordance with a priority enablement ordering. For example, when the battery is fully charged, or is a new battery, the priority enablement ordering may allow all of the functional circuits to be activate. As the battery power level decreases, indicating that the battery life is shortening, certain functional circuits are disabled. When the battery power level is near exhausted, the priority enablement ordering may only enable the wireless communication functionality such that the cellular telephone may receive and/or initiate a wireless communication.

The battery power level may be determined in a variety of ways. For example, the battery voltage may be compared with a plurality of voltage thresholds. When the battery voltage compares favorably to a highest threshold, an indication is provided indicating that the battery power level is fully charged and/or the battery is new. As the voltage level drops, the battery voltage will compare unfavorably to more and more thresholds until it reaches the lowest battery threshold indicating that the cellular telephone should be placed in a low battery mode thus, disabling all but the most critical function(s). In one embodiment, the most critical function may be the use of the cellular telephone for emergency calls. In another embodiment, however, the user may select the functions that are to be deemed critical and establish the ordering of which functions are disabled based on the decreasing battery power.

In one example embodiment, the priority enablement ordering may be wireless communication processing as the highest priority, followed by PDA functionality, followed by digital audio processing, followed by digital video processing. Accordingly, as the battery voltage drops, the digital video processing will be first disabled, then the digital audio processing, then the PDA functionality.

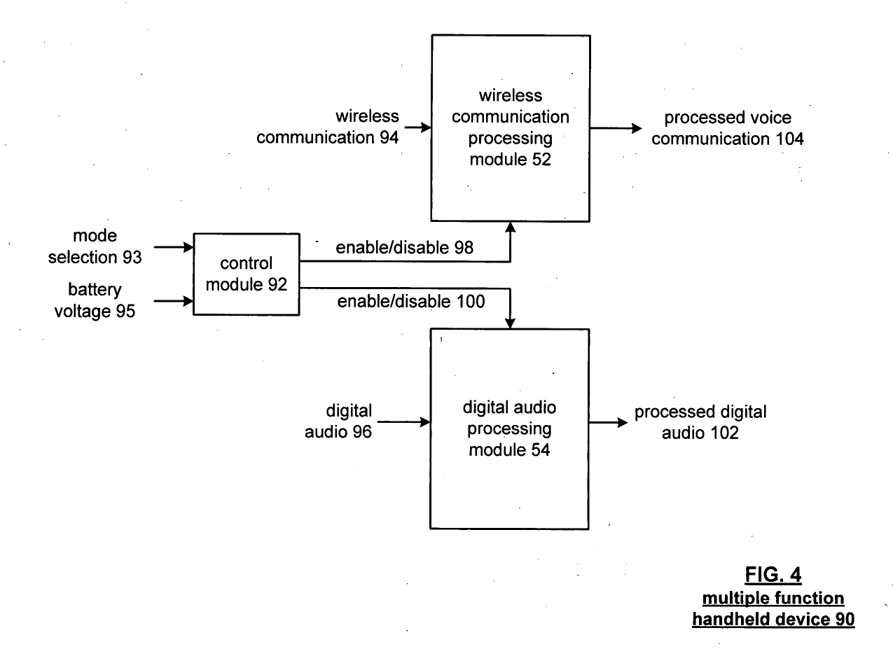

FIG. 4 is a schematic block diagram of a multiple function handheld device 90 that includes the wireless communication processing module 52, the digital audio processing module 54, and a control module 92. The control module 92 may be included within one or more of processing modules 52 and 54 or it may be a separate processing module.

The control module 92 is operably coupled to receive a mode select signal 93 and/or a battery voltage 95. In one embodiment, the control module 92, based on the mode select signal 93 enables or disables 98 processing module 52 and/or enables or disables 100 processing module 54. For example, in a 1st mode, the control module may disable the wireless communication processing module 52 while enabling the digital audio processing module 54. While enabled, the digital audio processing module 54 converts digital audio files 96 into processed digital audio 102, which may be an analog audio output or a digital audio output. In such a mode, the multiple function handheld 90 allows the user to be compliant with particular regulations of an environment (e.g., on an airplane where the use of cellular telephones is not permitted).

In another mode, the control module 92 may disable the audio processing module 54 and enable the wireless communication processing module 52. While enabled, the wireless communication processing module 52 processes wireless communications inbound and outbound 94 into processed voice communications 104. In another mode, the control module 92 may disable both processing modules 52 and 54. In yet another mode, the control module 92 may enable both processing modules 52 and 54.

The control module 92, while monitoring the battery voltage 95 may selectively enable or disable processing modules 52 and 54 based on the monitored battery voltage. In one embodiment, when the battery voltage 95 compares unfavorably to a threshold voltage, the control module 92 establishes a 1st power state. In the 1st power state, the control module 92 disables at least a portion of the audio processing functionality of the digital audio processing module 54 while enabling at the wireless communication functionality of the wireless communication processing module 52. If the battery voltage 95 compares favorably to the threshold voltage, the control module 92 establishes a 2nd power state. In the 2nd power state, the control module enables both processing modules 52 and 54.

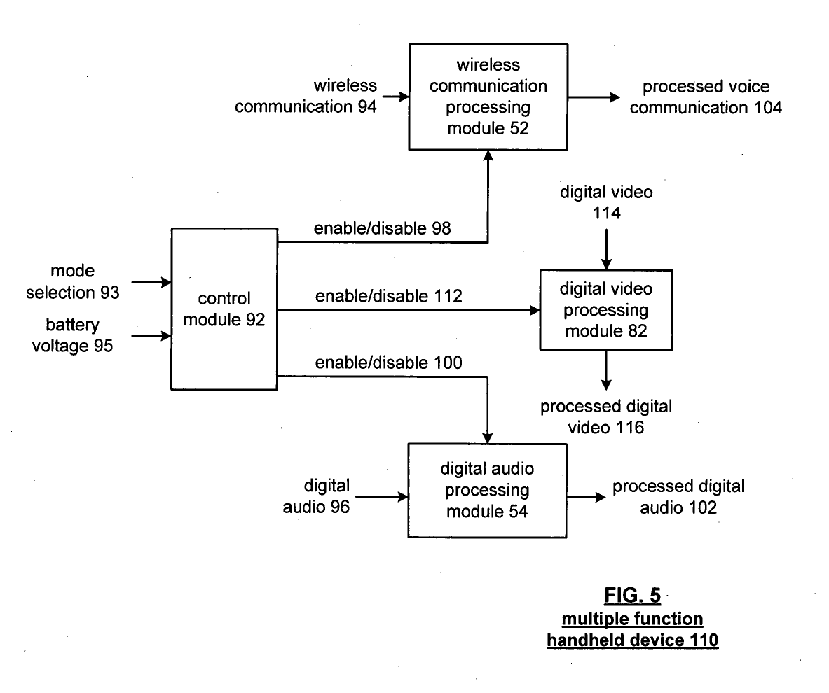

FIG. 5 is a schematic block diagram of another embodiment of a multiple function handheld device 110. In this embodiment, the multiple function handheld device 110 includes the wireless communication processing module 52, the digital audio processing module 54, the digital video processing module 82, and the control module 92. In this embodiment, the control module 92 may activate one or more of the processing modules 52, 54 and 82 based on the mode select signal 93.

In addition, the control module 92 may activate one or more of the processing modules 52, 54 and 82 based on the battery voltage 95. For instance, when the battery voltage compares favorably to a 1st voltage threshold, the control module 92 may enable all three processing modules 52, 54 and 82. When the battery voltage drops below the 1st threshold but is above a 2nd threshold, the control module may disable the video processing module 82, while enabling the digital audio processing module 54 and the wireless communication processing module 52. When the battery voltage 95 drops below a 2nd threshold but is above a 3rd threshold, the control module may enable the wireless communication processing module 52, but disable the digital video processing module 82 and the digital audio processing module 54. Note that when the digital video processing module 82 is enabled, it processes digital video 114 to produce processed digital video 116. The digital video may be stored MPEG files and/or stored JPEG which are rendered into an analog or digital video output for subsequent display.

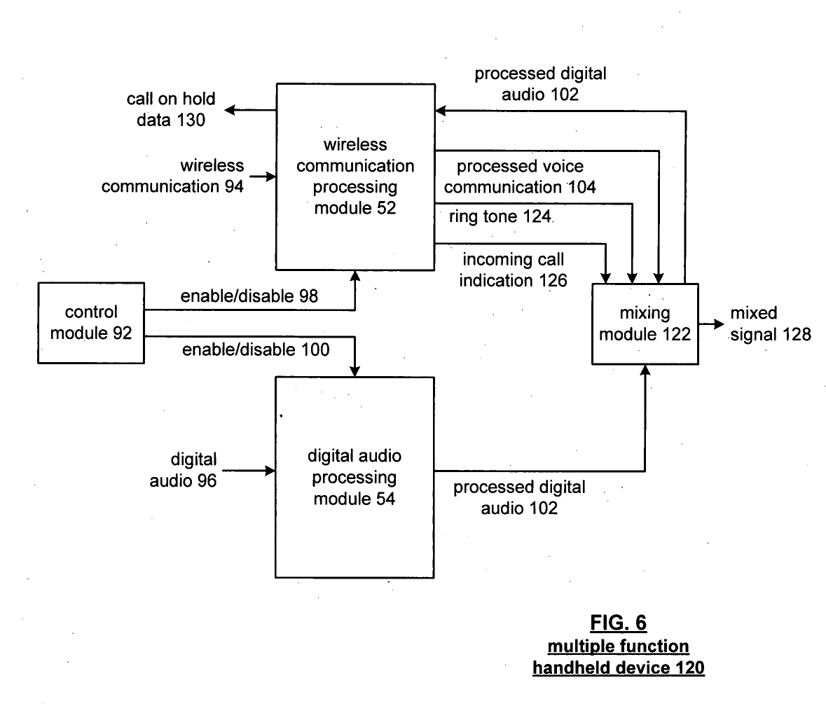

FIG. 6 is a schematic block diagram of yet another embodiment of a multiple function handheld device 120. In this embodiment, the multiple function handheld device 120 includes the wireless communication processing module 52, the digital audio processing module 54, control module 92 and a mixing module 122. In this embodiment, the wireless communication processing module 52, while processing a wireless communication, may generate processed voice communications 104, a ring tone 124, an incoming call indication 126, and/or call-on-hold data 130. The call-on-hold data may correspond to playback of a digital audio file 96 for a call that is on hold.

In this embodiment, the mixing module 122 may mix the processed digital audio 102 with one or more of the processed voice communications 104, ring tone 124 and/or incoming call indication 126. The volume levels at which the signals are mixed to produce mixed signal 128 may be varied. In addition, the processed digital audio 102 may be faded out as an incoming call is indicated.

When the wireless communication processing module 52 is facilitating an active wireless communication and has placed another wireless communication on hold, the mixing module 102 may provide the processed voice communications 104 to the speaker and/or headphone jack while also providing the processed digital audio 102 to the wireless communication processing device 52. The wireless communication processing device 52 provides the processed digital audio 102 for the wireless communication on hold as the call-on-hold data 130. In this instance, while a 3rd party is on hold, it is receiving playback of a digital audio file from the multiple function handheld device 120.

FIG. 7 is a schematic block diagram of yet another embodiment of a multiple function handheld device 140. In this embodiment, the multiple function handheld device 140 includes an RF transceiver 145, the digital audio processing module 54, display 30, I/O interface 58,.memory 56, microphone 34, headphone jack 32, speaker 36, and multiplexers 150 and 152. The digital audio processing module 54 includes a digital audio encoder 142 and a digital audio decoder 144. The RF transceiver 145 includes an RF transmit path which includes low pass filter 44, mixer 42 and power amplifier 40 and a receive path that includes low noise amplifier 50, mixer 48 and low pass filter 46.

In this embodiment, the digital audio processing module 54 may process digital audio files stored in memory 56 and/or as a digital voice recorder as previously described. In addition, the digital audio processing module 54 may further function to provide the baseband processing of incoming and outgoing wireless communications.

For wireless communications, the audio signals received via microphone 34 are provided to the digital audio encoder 142. The digital audio encoder 142 encodes the audio signals to produce outgoing baseband signals. The RF transceiver 145 converts the outgoing baseband signals into outgoing RF signals that are transmitted to a base station for relaying to another cellular telephone user, dispatch center, and/or other walkie talkie user. The RF transceiver 145 also receives inbound RF signals that are converted into inbound baseband signals. The digital audio decoder 144 converts the inbound baseband signals into a monotone audio signal 146 (or stereo signal) that is subsequently provided to the speaker 36 or headphone jack 32.

In such an embodiment, the digital audio encoder 142 and digital audio decoder 144 may include a combination of wireless communication baseband processing and digital audio processing where common components are shared but function essentially separately. Alternatively, the digital audio encoding and digital audio decoding may be in accordance with a digital audio standard being supported by the multiple function handheld device wherein the baseband signals of the wireless communication function are at least partially encoded/decoded based on the digital audio standard. For example, the digital audio encoding 142 and digital audio decoding 144 may be done in accordance with a particular digital audio file format such as MP3, WMA, et cetera wherein the digital audio file format signals are converted into inbound and/or outbound baseband signals to support a wireless communication.

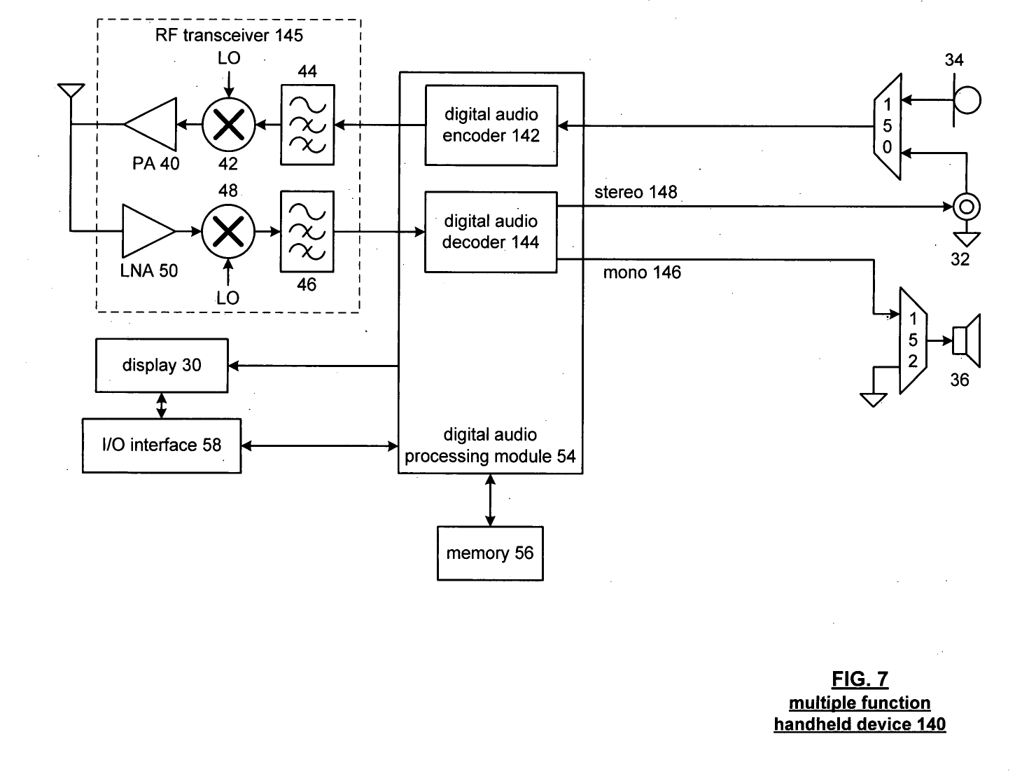

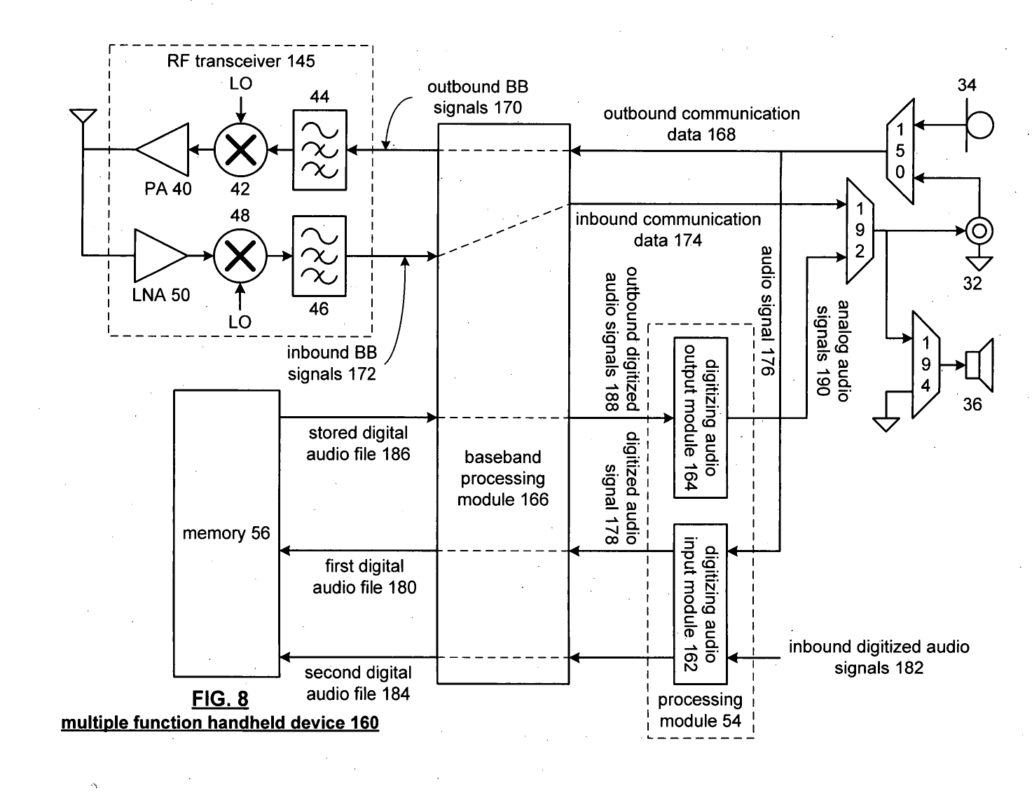

FIG. 8 is a schematic block diagram of yet another embodiment of a multiple function handheld device 160. In this embodiment, the handheld device 160 includes the RF transceiver 145, a baseband processing module 166, memory 56, audio processing module 54, the microphone 34, headphone jack 32, speaker 36 and multiplexers 150, 192 and 194. In this embodiment, the baseband processing module 166 processes inbound baseband signals 172 and outbound baseband signals 170 in accordance with the wireless communication protocol or protocols being supported by the handheld device 130. Such a wireless communication protocol may be GSM, CDMA, et cetera.

The baseband processing module 166 functions to convert stored digital audio files 186, which are stored in a format corresponding to a wireless communication protocol, into outbound digitized audio signals 188. In this instance, the processing module 54 includes a digitizing audio output module 164 and digitizing audio input module 162. The digitizing audio output module 164 converts the outbound digitized audio signals 188 into analog output signals 190 which may be provided to the headphone jack 32 or speaker 36 via multiplexers 192 and 194. Alternatively, multiplexers 192 and 194 may provide the inbound communication data 174 from the baseband processing module 166 to headphone jack 32 or speaker 36.

The digitizing audio input module 162 may provide audio signals 176, via microphone 34, as digitized audio signals 178 to the baseband processing module 166. The baseband processing module 166 converts the digitized audio signals 178 into a digital audio file 180 that may be stored in memory 56. Additionally, the digitizing audio input module 162 may pass inbound digitized audio signals 182 to the baseband processing module 166. The baseband processing module 166 converts the inbound digitized audio signals 182 into a 2nd digital audio file 184, which may be stored in memory 56. The conversion of digitized audio signals 178 and/or 182 into digital audio files 180 or 184 may be done in accordance with the encoding performed by the baseband processing module 166 that it utilizes to encode outbound communication data 168 into outbound baseband signals 170.

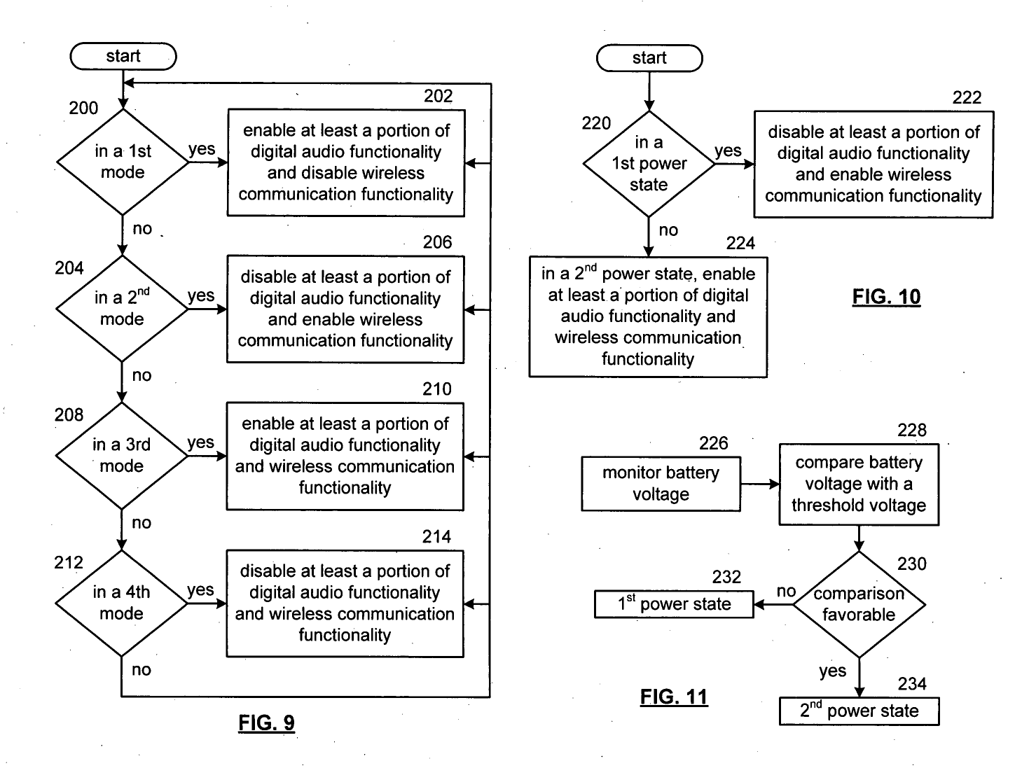

FIG. 9 is a logic diagram of a method for enabling functional circuits of a multiple function handheld device. The process begins at Step 200 where a determination is made as to whether the handheld device is in a 1st mode. If so, the process proceeds to Step 202 where at least a portion of the digital audio functionality is enabled and the wireless communication functionality is disabled. In one embodiment, the digital audio functionality includes at least one of digital audio playback, digital audio record, file transfer, digital audio encode and digital audio decode. In an embodiment, the wireless communication functionality includes at least one of cellular telephone communication processing, walkie talkie communication processing and dispatch communication processing. In another embodiment, the handheld device may include digital video functionality that may be enabled when the device is in the 1st mode. In one embodiment, the digital video functionality includes at least one of digital motion video playback, digital still image video playback, digital motion video record, digital still image record, digital video encode and digital video decode.

The handheld device may be placed in the 1st mode by detecting selection of the 1st mode by interpreting a menu selection, interpreting a button activation via the keyboard, and/or interpreting proximity based wireless communication information. For example, the proximity based wireless communication information may be a wireless communication indicating that the handheld device should be placed in the 1st mode.

If the device is not in the 1st mode, the process proceeds to Step 202 to determine whether it is in a 2nd mode. If so, the at least a portion of the digital audio functionality is disabled while the wireless communication functionality is enabled.

If the device is not in the 2nd mode, a determination is made as to whether it is in a 3rd mode. If the device is in a 3rd mode, the digital audio functionality and wireless communication functionality are enabled.

If the device is not in the 3rd mode, a determination is made as to whether it is in a 4th mode. If the device is in a 4th mode, the process proceeds to Step 214 where the digital audio functionality and wireless communication functionality are disabled.

FIG. 10 is a logic diagram of a method for power conservation of a multiple function handheld device. The process begins at Step 220 where a determination is made as to whether the device is in a 1st power state. The determination of the 1st power state will be described in greater detail with reference to the logic diagram of FIG. 11. When the device is in a 1st power state, the process proceeds to Step 222 where at least a portion of the digital audio functionality is disabled and the wireless communication functionality is enabled.

If the device is not in the 1st power state, the process proceeds to Step 224 where, in a 2nd power state, the digital audio functionality and wireless communication functionality are enabled.

FIG. 11 is a logic diagram for determining whether the handheld device is in a 1st power state. The process begins at Step 226 where a battery voltage is monitored. The process then proceeds to Step 228 where the battery voltage is compared with a threshold voltage. The process then proceeds to Step 230 where a determination is made as to whether the comparison of Step 228 is favorable. If not, the process proceeds to Step 232 where an indication that the device is in the 1st power state is made. If the comparison is favorable, the process proceeds to Step 234 where an indication that the device is in the 2nd power state is made.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”. As one of ordinary skill in the art will further appreciate, the term “operably associated with”, as may be used herein, includes direct and/or indirect coupling of separate components and/or one component being embedded within another component. As one of ordinary skill in the art will still further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The preceding discussion has presented a variety of method and apparatus for enabling and/or power conservation of multiple functions of a multiple function handheld device. As one of ordinary skill in the art will appreciate, other embodiments of the present invention may be derived from the teachings contained herein without deviating from the scope of the claims.

What is claimed is:

1. A method comprises:
monitoring a battery voltage;
comparing the battery voltage with a threshold voltage;
when the battery voltage compares unfavorably to the threshold voltage, establishing the first power state;
disabling at least a portion of a digital audio processing functionality in response to the first power state; and
enabling wireless communication functionality in response to the first power state.

2. The method of claim 1 further comprises:
enabling the at least a portion of the digital audio processing functionality in response to a second power state; and
enabling the wireless communication functionality in response to the second power state.

3. The method of claim 2 further comprises:
comparing the battery voltage with a second threshold voltage;
when the battery voltage compares favorably to the second threshold voltage, establishing the second power state.

4. The method of claim 1, wherein the disabling the at least a portion of the digital audio processing functionality in response to the first power state comprises:
producing a disable signal in response to the first power state, wherein the at least a portion of the digital audio processing functionality is disabled in accordance with the disable signal.

5. The method of claim 1, wherein the disabling the at least a portion of the digital audio processing functionality in response to the first power state comprises:
producing a low battery indicate in response to the first power state;
receiving a disable request in response to the low battery indication; and
producing a disable signal in response to the disable request, wherein the at least a portion of the digital audio processing functionality is disabled in accordance with the disable signal.

6. The method of claim 1 further comprises:
disabling at least a portion of a digital video processing functionality in response to the first power state.

7. The method of claim 6, wherein the at least a portion of the digital video functionality comprises at least one of:
digital motion video playback;
digital still image video playback;
digital motion video record;
digital still image record;
digital video encode; and
digital video decode.

8. The method of claim 1, wherein the at least a portion of the digital audio functionality comprises at least one of:
digital audio playback;
digital audio record;
file transfer;
digital audio encode; and
digital audio decode.

9. The method of claim 1, wherein the wireless communication functionality comprises at least one of:
cellular telephone communication processing;
walkie-talkie communication processing; and
dispatch communication processing.

10. An apparatus comprises:
a control module operably coupled to:
monitor a battery voltage;
compare the battery voltage with a threshold voltage;
when the battery voltage compares unfavorably to the threshold voltage, establish the first power state;
a digital audio processing module disabled in the first power state from processing digital audio; and
a wireless communication processing module operable in the first power state to process a wireless communication.

11. The apparatus of claim 10 further comprises:
the digital audio processing module operable in a second power state to process the digital audio; and
the wireless communication processing module operable in the second power state to process the wireless communication.

12. The apparatus of claim 11, wherein the control module further functions to:
compare the battery voltage with a second threshold voltage;
when the battery voltage compares favorably to the second threshold voltage, establish the second power state.

13. The apparatus of claim 10, wherein the control module further functions to:
produce a disable signal in response to the first power state, wherein the at least a portion of the digital audio processing functionality is disabled in accordance with the disable signal.

14. The apparatus of claim 10, wherein the control module further functions to:
produce a low battery indicate in response to the first power state;
receive a disable request in response to the low battery indication; and
produce a disable signal in response to the disable request, wherein the at least a portion of the digital audio processing functionality is disabled in accordance with the disable signal.

15. The apparatus of claim 10 further comprises:
a digital video processing module disabled in the first power state from processing digital video.

16. The apparatus of claim 15, wherein the processing the digital video comprises at least one of:
digital motion video playback;
digital still image video playback;
digital motion video record;
digital still image record;
digital video encode; and
digital video decode.

17. The apparatus of claim 10, wherein the processing the digital audio comprises at least one of:
digital audio playback;
digital audio record;
file transfer;
digital audio encode; and
digital audio decode.

18. The apparatus of claim 10, wherein the processing the wireless communication comprises at least one of:
cellular telephone communication processing;
walkie-talkie communication processing; and
dispatch communication processing.
